(19) United States
(12) Patent Application Publication
(10) Pub. No.: US 2021/0261789 A1
(43) Pub. Date: Aug. 26, 2021

(54) Coating Compositions Containing Lignin and Coatings Formed Therefrom

(71) Applicant: PPG Industries Ohio, Inc., Cleveland, OH (US)

(72) Inventors: Matthew William Skinner, Pittsburgh, PA (US); Daniel K. Dei, Pittsburgh, PA (US); Adam Bradley Powell, Wexford, PA (US)

(21) Appl. No.: 16/801,803

(22) Filed: Feb. 26, 2020

(51) Int. Cl. C09D 5/03; C09D 167/00; C09D 163/04; C09D 133/10; C09D 197/00; C08K 5/00; B05D 7/14

(52) U.S. Cl. CPC C09D 5/03; C09D 167/00; C09D 163/04; C09D 133/10; B05D 2202/00; C08K 5/0025; B05D 7/14; B05D 2401/32; C09D 197/005

(57) ABSTRACT

A powder coating composition includes: a film-forming resin; a lignin polymer that is substantially free of sulfonate or sulfonic acid groups; and a crosslinker reactive with functional groups of the film-forming resin and the lignin polymer. The lignin polymer includes at least 5 weight % of the powder coating composition, based on the total solids weight of the powder coating composition. Further, when cured to form a coating, the film-forming resin and lignin polymer react and chemically bond with the crosslinker to form a binder of the coating.

### FIELD OF THE INVENTION

The present invention relates to coating compositions containing lignin and coatings formed from such compositions.

### BACKGROUND OF THE INVENTION

Coatings are applied to substrates to provide numerous properties including protective properties, decorative properties, and the like. These coatings can be formed from various types of compositions. For instance, coatings are commonly formed from solid powder compositions to provide protective properties and/or decorative properties over various types of substrates, such as metal substrates. While powder compositions can be used to produce coatings having advantageous and desirable properties, they are typically formed from resinous materials that are expensive, thereby increasing the overall cost of the powder compositions. Thus, it is desirable to provide powder coating compositions that are formed from low-cost materials and which form coatings having good protective and/or decorative properties.

### SUMMARY OF THE INVENTION

The present invention relates to a powder coating composition including: a film-forming resin; a lignin polymer that is substantially free of sulfonate groups; and a crosslinker reactive with functional groups of the film-forming resin and the lignin polymer. The lignin polymer includes at least 5 weight % of the powder coating composition, based on the total solids weight of the powder coating composition. Further, when cured to form a coating, the film-forming resin and lignin polymer react and chemically bond with the crosslinker to form a binder of the coating.

### DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise. For example, “a” film-forming resin, “a” lignin polymer, “a” crosslinker, and the like refer to one or more of any of these items.

As indicated, the present invention relates to a powder coating composition that comprises a film-forming resin, a lignin polymer, and a crosslinker reactive with functional groups of the film-forming resin and the lignin polymer.

As used herein, a “powder coating composition” refers to a coating composition embodied in solid particulate form as opposed to liquid form. Thus, the components that form the powder coating composition can be combined to form a curable solid particulate powder coating composition. For instance, the film-forming resin, lignin polymer, crosslinker, and optional additional components can be combined to form a curable solid particulate powder coating composition that is free flowing. As used herein, the term “free flowing” with regard to curable solid particulate powder coating compositions of the present invention, refers a curable solid particulate powder composition having a minimum of clumping or aggregation between individual particles.

As previously described, the powder coating composition comprises a film-forming resin. As used herein, a “film-forming resin” refers to a self-supporting continuous film on at least a horizontal surface of a substrate upon removal of any diluents or carriers present in the composition or upon curing. Further, as used herein, the term “resin” is used interchangeably with “polymer,” and the term polymer refers to oligomers and homopolymers (e.g., prepared from a single monomer species), copolymers (e.g., prepared from at least two monomer species), terpolymers (e.g., prepared from at least three monomer species), graft polymers, and block copolymers.

The terms “curable”, “cure”, and the like, as used in connection with a coating composition, means that at least a portion of the components that make up the coating composition are polymerizable and/or crosslinkable. The coating composition of the present invention can be cured at ambient conditions, with heat, or with other means such as actinic radiation. The term “actinic radiation” refers to electromagnetic radiation that can initiate chemical reactions. Actinic radiation includes, but is not limited to, visible light, ultraviolet (UV) light, X-ray, and gamma radiation. Further, “ambient conditions” refers to the conditions of the surrounding environment (e.g., the temperature, humidity, and pressure of the room or outdoor environment in which the substrate is located such as, for example, at a temperature of 23° C. and at a relative humidity in the air of 35% to 75%).

The film-forming resin of the present invention is selected from one or more thermosetting film-forming resins. As used herein, the term “thermosetting” refers to resins that “set” irreversibly upon curing or crosslinking, wherein the polymer chains of the polymeric components are joined together by covalent bonds. Once cured or crosslinked, a thermosetting resin will not melt upon the application of heat and is insoluble in solvents.

Non-limiting examples of suitable film-forming resins include epoxy resins, polyester polymers, (meth)acrylic polymers, polyurethanes, polyamide polymers, polyether polymers, polysiloxane polymers, vinyl resins, copolymers thereof, and mixtures thereof. The film-forming resins of the present invention include one or more functional groups such as, for example, carboxylic acid groups, epoxide groups, hydroxyl groups, amine groups, alkoxy groups, thiol groups, carbamate groups, amide groups, urea groups, isocyanate groups (including blocked isocyanate groups), and combinations thereof. For example, the film-forming resin can comprise a carboxylic acid polyester polymer and/or an epoxy functional resin such as a bisphenol A epoxy functional resin (e.g., a diglycidyl ether of bisphenol A).

The film-forming resins used with the present invention can also have a glass transition temperature (T_{g}) of at least 45° C., at least 50° C., at least 55° C., or at least 60° C. The T_{g} is based on information from commercially available resins and can also be determined using differential scanning calorimetry (DSC).

The coating composition of the present invention can comprise from 5 to 90 weight %, 15 to 87 weight %, such as 20 to 85 weight % or 29 to 82 weight % of one or more film-forming resins, based on the total solids weight of the coating composition. The ratio of film-forming resin to lignin in the coating composition of the present invention may range from 1:1 to 9:1, such as 4:1 to 9:1 or 1:1 to 4:1, based on the total solids weight of the coating composition.

As previously described, the powder coating composition also comprises a lignin polymer. As used herein, a “lignin polymer” is a biopolymer that comprises aromatic rings and at least hydroxyl and alkoxy groups, and which is obtained from natural sources such as plant cell walls. For instance, lignin polymer can be extracted from various sources including, but not limited to, jute, hemp, cotton, wood pulp, pine straw, wheat straw, alfalfa, kenaf, and flax fiber.

The lignin polymer used in the powder coating composition of the present invention is substantially free of sulfonate or sulfonic acid groups. The lignin polymer used in the powder coating composition of the present invention can also be essentially free or completely free of sulfonate or sulfonic acid groups. The term “substantially free of sulfonate or sulfonic acid groups” means that the lignin polymer contains less than 1000 parts per million by weight (ppm) of sulfonate or sulfonic acid groups based on the total solids weight of the lignin polymer, “essentially free of sulfonate or sulfonic acid groups” means that the lignin polymer contains less than 100 ppm of sulfonate or sulfonic acid groups based on the total solids weight of the lignin polymer, and “completely free of sulfonate or sulfonic acid groups” means that the lignin polymer contains less than 20 parts per billion by weight (ppb) of sulfonate or sulfonic acid groups based on the total solids weight of the lignin polymer. Further, the term “sulfonate group” refers to a sulfur-containing functional group of the formula R—SO₃⁻ where R is an organic element such as carbon, and the oxygens are covalently bound to a sulfur element by either single or double bonds. In sulfonate-containing species a positive charged group would also be present to allow for charge neutrality. The term “sulfonic acid group” refers to a sulfur-containing functional group of the formula R—SO₃H where R is an organic element such as carbon, and the oxygens are covalently bound to a sulfur element by either single or double bonds.

It will be appreciated that lignin containing sulfonate or sulfonic acid groups are typically obtained from a sulfite pulping process. As such, the lignin polymer used with the present invention is not obtained from a sulfite pulping process or another process that produces sulfonated lignin, which is also referred to as lignosulfonates. The lignin polymer may be substantially free, essentially free, or completely free of Klason, which is the insoluble portion of lignin that remains after reacting the lignin precursor with concentrated sulfuric acid. Trace amounts of Klason lignin that may be present in the coating composition are not intentionally added. The term “substantially free of Klason lignin” means that the coating composition contains less than 1000 parts per million by weight (ppm) of Klason lignin based on the total solids weight of the composition, “essentially free of Klason lignin” means that the coating composition contains less than 100 ppm of a Klason lignin based on the total solids weight of the composition, and “completely free of Klason lignin” means that the coating composition contains less than 20 parts per billion by weight (ppb) of Klason lignin based on the total solids weight of the composition.

Non-limiting examples of lignin polymers that can be used with the powder coating compositions of the present invention include organosolv lignin, Kraft lignin (lignin derived from a hydrosulfide/alkaline media pulping process), soda lignin, lignin derived from ethanol production processes, lignin derived from a liquid extraction process such as an aqueous solvent extraction, an organic solvent extraction, or some combination thereof, or lignin processed near or at a neutral pH and combinations thereof. An “organosolv lignin” refers to lignin that is obtained from a purification process that uses organic solvent to solubilize lignin.

The powder coating composition of the present invention can comprise at least 5 weight %, at least 9 weight %, at least 15 weight %, at least 20 weight %, or at least 30 weight % of the lignin polymer, based on the total solids weight of the coating composition. The powder coating composition of the present invention can also comprise up to 80 weight %, up to 70 weight %, up to 60 weight %, up to 50 weight %, up to 45 weight %, or up to 40 weight % of the lignin polymer, based on the total solids weight of the coating composition. The powder coating composition of the present invention can also comprise an amount of lignin polymer within a range such as, for example, from 5 to 80 weight %, 9 to 70 weight %, 15 to 60 weight %, 20 to 50 weight %, or 25 to 40 weight % of the lignin polymer, based on the total solids weight of the coating composition.

The powder coating composition of the present invention also comprises a crosslinker that is reactive with the functional groups of the film-forming resin and the lignin polymer. As used herein, the term “crosslinker” refers to a molecule comprising two or more functional groups that are reactive with other functional groups and which is capable of linking two or more monomers or polymer molecules through chemical bonds such as during a curing process. Thus, the coating composition comprises a crosslinker having functional groups that are reactive with at least some of the functional groups on the film-forming resin and the lignin polymer.

Non-limiting examples of crosslinkers include hydroxyl functional compounds including for example hydroxyl alkyl amides and hydroxyl alkyl ureas, phenolic functional compounds, epoxy compounds, triglycidyl isocyanurate, alkylated carbamates, isocyanates, polyacids, anhydrides, organometallic acid-functional materials, polyamines, polyamides, aminoplasts, uretdiones such as polyuretdiones, and combinations thereof. As used herein, a “polyamine” is any molecule having two or more amine groups. The polyamine may include an aromatic polyamine.

The powder coating composition of the present invention can comprise at least 2 weight %, at least 5 weight %, or at least 10 weight % of the crosslinker, based on the total solids weight of the coating composition. The powder coating composition of the present invention can also comprise up to 30 weight %, up to 20 weight %, or up to 15 weight % of the crosslinker, based on the total solids weight of the coating composition. The powder coating composition of the present invention can also comprise an amount of crosslinker within a range such as, for example, from 2 to 30 weight %, 5 to 20 weight %, or 10 to 15 weight % of the crosslinker, based on the total solids weight of the coating composition.

It is appreciated that the functional groups on the crosslinker react and chemically bond with the functional groups on the film-forming resin and lignin polymer to crosslink the film-forming resin and lignin polymer when cured to form the binder of the resulting coating. As used herein, a “binder” refers to a main constituent material that holds all components together upon curing of the coating composition.

The coating composition can also comprise additional components. For example, the coating composition can also comprise one or more thermoplastic resins in addition to the one or more thermosetting film-forming resins. As used herein, the term “thermoplastic” refers to resins that include polymeric components that are not joined by covalent bonds and, thereby, can undergo liquid flow upon heating and are soluble in solvents. Alternatively, the coating composition of the present invention is substantially free, essentially free, or completely free of a thermoplastic resin. The term “substantially free of a thermoplastic resin” means that the coating composition contains less than 1000 parts per million by weight (ppm) of a thermoplastic resin based on the total solids weight of the composition, “essentially free of a thermoplastic resin” means that the coating composition contains less than 100 ppm of a thermoplastic resin based on the total solids weight of the composition, and “completely free of a thermoplastic resin” means that the coating composition contains less than 20 parts per billion by weight (ppb) of a thermoplastic resin based on the total solids weight of the composition.

The coating compositions can also comprise a colorant. As used herein, “colorant” refers to any substance that imparts color and/or other opacity and/or other visual effect to the composition. The colorant can be added to the coating in any suitable form, such as discrete particles, dispersions, solutions, and/or flakes, such as metal flakes. A single colorant or a mixture of two or more colorants can be used in the coatings of the present invention.

Example colorants include pigments (organic or inorganic), dyes and tints, such as those used in the paint industry and/or listed by the Color Pigments Manufacturers Association, Inc. (CPMA), as well as special effect compositions. A colorant may include, for example, a finely divided solid powder that is insoluble, but wettable, under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, diazo, naphthol AS, benzimidazolone, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black, and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, and perylene and quinacridone.

Example tints include, but are not limited to, pigments dispersed in water-based or water miscible carriers such as AQUA-CHEM 896 commercially available from Degussa, Inc., and CHARISMA COLORANTS and MAXITONER INDUSTRIAL COLORANTS commercially available from Accurate Dispersions Division of Eastman Chemical, Inc.

The colorant used may also comprise a special effect composition or pigment. As used herein, a “special effect composition or pigment” refers to a composition or pigment that interacts with visible light to provide an appearance effect other than, or in addition to, a continuous unchanging color. Suitable special effect compositions and pigments include those that produce one or more appearance effects such as reflectance, pearlescence, metallic sheen, texture, phosphorescence, fluorescence, photochromism, photosensitivity, thermochromism, goniochromism, and/or color-change, such as transparent coated mica and/or synthetic mica, coated silica, coated alumina, aluminum flakes, a transparent liquid crystal pigment, a liquid crystal coating, and combinations thereof.

The coating composition can also comprise a catalyst that catalyzes the crosslinking reaction of the film-forming resin, the lignin polymer, and the crosslinker. Non-limiting examples of suitable catalysts include amine catalyst such as dimethyl lauryl amine. Alternatively, the curable coating composition of the present invention is substantially free, essentially free, or completely free of a catalyst. The term “substantially free of a catalyst” means that the coating composition contains less than 1000 parts per million by weight (ppm) of a catalyst based on the total solids weight of the composition, “essentially free of a catalyst” means that the coating composition contains less than 100 ppm of a catalyst based on the total solids weight of the composition, and “completely free of a catalyst” means that the coating composition contains less than 20 parts per billion by weight (ppb) of a catalyst based on the total solids weight of the composition.

Other non-limiting examples of components that can be used with the coating compositions of the present invention include plasticizers, abrasion resistant particles, fillers including, but not limited to, micas, talc, clays, and inorganic minerals, anti-oxidants, hindered amine light stabilizers, UV light absorbers and stabilizers, flow and surface control agents, thixotropic agents, reaction inhibitors, degassing agents, and other customary auxiliaries.

The powder coating composition can be prepared by mixing the previously described components in solid form. It will be appreciated that some optional additives can be provided as a liquid or dispersion and formed into a solid material. The solid components are mixed such that a homogenous mixture is formed. The solid components can be mixed using art-recognized techniques and equipment such as with a Prism high speed mixer for example. The homogenous mixture is then melted and further mixed. The mixture can be melted with a twin screw extruder or a similar apparatus known in the art. During the melting process, the temperatures will be chosen to melt mix the solid homogenous mixture without curing the mixture. After melt mixing, the mixture is cooled and re-solidified. The re-solidified mixture is then ground such as in a milling process to form a solid particulate curable powder coating composition. The re-solidified mixture can be ground to any desired particle size. For example, in an electrostatic coating application, the re-solidified mixture can be ground to an average particle size of at least 10 microns or at least 20 microns and up to 100 microns as determined with a Beckman-Coulter LS™ 13 320 Laser Diffraction Particle Size Analyzer following the instructions described in the Beckman-Coulter LS™ 13 320 manual. Further, the particle size range of the total amount of particles in a sample used to determine the average particle size can comprise a range of from 1 micron to 200 microns, or from 5 microns to 180 microns, or from 10 microns to 150 microns, which is also determined with a Beckman-Coulter LS™ 13 320 Laser Diffraction Particle Size Analyzer following the instructions described in the Beckman-Coulter LS™ 13 320 manual.

The coating composition of the present invention can be applied to various substrates including, but not limited to, automotive substrates and components (e.g. automotive vehicles including, but not limited to, cars, buses, trucks, trailers, etc.), industrial substrates, aircraft and aircraft components, marine substrates and components such as ships, vessels, and on-shore and off-shore installations, storage tanks, windmills, nuclear plants, pipes, packaging substrates, wood flooring and furniture, apparel, electronics, including housings and circuit boards, glass and transparencies, sports equipment, including golf balls, stadiums, buildings, bridges, and the like. These substrates can be, for example, metallic or non-metallic.

The coating composition of the present invention may be used as a fusion bonded epoxy coating for pipes, fittings, joints, and other small parts. As used herein, a “fusion bonded epoxy coating” refers to an epoxy-based coating that results from a coating composition that is applied to a substrate at a high temperature, typically greater than 350° F. (177° C.), causing the coating composition to melt and chemically crosslink. The resulting coating is a thermoset coating with increased corrosion protection.

Metallic substrates include, but are not limited to, tin, steel (including electrogalvanized steel, cold rolled steel, hot-dipped galvanized steel, steel alloys, or blasted/profiled steel, among others), aluminum, aluminum alloys, zinc-aluminum alloys, steel coated with a zinc-aluminum alloy, and aluminum plated steel. As used herein, blasted or profiled steel refers to steel that has been subjected to abrasive blasting and which involves mechanical cleaning by continuously impacting the steel substrate with abrasive particles at high velocities using compressed air or by centrifugal impellers. The abrasives are typically recycled/reused materials and the process can efficiently removal mill scale and rust. The standard grades of cleanliness for abrasive blast cleaning is conducted in accordance with BS EN ISO 8501-1.

Further, non-metallic substrates include polymeric and plastic substrates including polyester, polyolefin, polyamide, cellulosic, polystyrene, polyacrylic, poly(ethylene naphthalate), polypropylene, polyethylene, nylon, EVOH, polylactic acid, other “green” polymeric substrates, poly(ethylene terephthalate) (PET), polycarbonate, polycarbonate acrylobutadiene styrene (PC/ABS), polyamide, wood, veneer, wood composite, particle board, medium density fiberboard, cement, stone, glass, paper, cardboard, textiles, leather, both synthetic and natural, and the like. It is appreciated that the coating compositions can be applied to various areas of any of the previously described substrates to form a continuous solid coating such as over the body and edges of a substrate and which provides the superior properties described herein.

The coating compositions of the present invention are particularly beneficial when applied directly to a metallic substrate or a pretreated metallic substrate. For example, the curable coating compositions of the present invention are particularly beneficial when applied to metallic substrates that form at least a portion of automotive vehicles.

The coating compositions of the present invention can be applied by any means standard in the art, such as spraying, electrostatic spraying, and the like. The coatings formed from the coating compositions of the present invention can be applied to a dry film thickness of 10 to 2000 microns, such as 10 to 1000 microns, 50 to 900 microns, or 300 to 800 microns.

The coating composition can be applied to a substrate to form a monocoat. As used herein, a “monocoat” refers to a single layer coating system that is free of additional coating layers. Thus, the coating composition can be applied directly to a substrate and cured to form a single layer coating, i.e. a monocoat. When the curable coating composition is applied to a substrate to form a monocoat, the coating composition can include additional components to provide other desirable properties. For example, the curable coating composition can also include an inorganic component that acts as a corrosion inhibitor. As used herein, a “corrosion inhibitor” refers to a component such as a material, substance, compound, or complex that reduces the rate or severity of corrosion of a surface on a metal or metal alloy substrate. The inorganic component that acts as a corrosion inhibitor can include, but is not limited to, an alkali metal component, an alkaline earth metal component, a transition metal component, or combinations thereof.

The term “alkali metal” refers to an element in Group 1 (International Union of Pure and Applied Chemistry (IUPAC)) of the periodic table of the chemical elements, and includes, e.g., cesium (Cs), francium (Fr), lithium (Li), potassium (K), rubidium (Rb), and sodium (Na). The term “alkaline earth metal” refers to an element of Group 2 (IUPAC) of the periodic table of the chemical elements, and includes, e.g., barium (Ba), beryllium (Be), calcium (Ca), magnesium (Mg), and strontium (Sr). The term “transition metal” refers to an element of Groups 3 through 12 (IUPAC) of the periodic table of the chemical elements, and includes, e.g., titanium (Ti), Chromium (Cr), and zinc (Zn), among various others.

Alternatively, the curable coating composition can be applied over a first coating layer deposited over a substrate to form a multi-layer coating system. For example, one or more coating compositions can be applied to a substrate and the curable coating composition previously described can be applied over the coating layers as a basecoat and/or topcoat. A “basecoat” refers to a coating composition from which a coating is deposited onto a primer and/or directly onto a substrate, optionally including components (such as pigments) that impact the color and/or provide other visual impact, and which may be overcoated with a protective and/or decorative topcoat.

It was found that the curable powder coating compositions of the present invention provide good/desirable protective and/or decorative properties when applied to a substrate, such as a metallic substrate, and cured to form a coating. For instance, the coatings formed from the powder coating compositions of the present invention have been found to provide good corrosion resistance, impact resistance, chemical resistance, gel times, and adhesion as well as desirable gloss control. The cost of preparing the coating compositions is also significantly lower than typical powder coating compositions know in the art since the coating compositions are prepared with large amounts of the lignin polymer, thereby reducing the amount of other more expensive film-forming resins.

The present invention also includes the following clauses.

Clause 1: A powder coating composition comprising: a film-forming resin; a lignin polymer that is substantially free of sulfonate or sulfonic acid groups; and a crosslinker reactive with the functional groups of the film-forming resin and the lignin polymer, wherein the lignin polymer comprises at least 5 weight % of the powder coating composition, based on the total solids weight of the powder coating composition, and wherein, when cured to form a coating, the film-forming resin and lignin polymer react and chemically bond with the crosslinker to form a binder of the coating.

Clause 2: The powder coating composition of clause 1, wherein the lignin polymer comprises at least 9 weight % of the powder coating composition, based on the total solids weight of the powder coating composition.

Clause 3: The powder coating composition of clause 1, wherein the lignin polymer comprises at least 20 weight % of the powder coating composition, based on the total solids weight of the powder coating composition.

Clause 4: The powder coating composition of any preceding clause, wherein the lignin polymer is completely free of sulfonate or sulfonic acid groups.

Clause 5: The powder coating composition of any preceding clause, wherein the lignin is selected from an organosolv lignin, Kraft lignin, soda lignin, lignin derived from a liquid extraction processes or ethanol production processes, or combinations thereof.

Clause 6: The powder coating composition of any preceding clause, wherein the film-forming resin comprises a polyester polymer, an epoxy polymer, an (meth)acrylic polymer, a copolymer thereof, or combinations thereof.

Clause 7: The powder coating composition of any preceding clause, wherein the film-forming resin comprises a carboxylic acid functional polyester polymer.

Clause 8: The powder coating composition of any one of clauses 1-6, wherein the film-forming resin comprises an epoxy functional resin.

Clause 9: The powder coating composition of clause 8, wherein the epoxy functional resin comprises a bisphenol A epoxy functional resin.

Clause 10: The powder coating composition of any preceding clause, wherein the film-forming resin has a glass transition temperature of at least 45° C.

Clause 11: The powder coating composition of any preceding clause, wherein the crosslinker comprises an epoxy functional crosslinker, a phenolic functional crosslinker, an isocyanate functional crosslinker, a hydroxyl functional crosslinker, or a combination thereof.

Clause 12: The powder coating composition of any preceding clause, further comprising a catalyst.

Clause 13: The powder coating composition of any preceding clause, wherein the coating composition is substantially free of a catalyst.

Clause 14: A substrate at least partially coated with the coating formed from the powder coating composition of any preceding clause.

Clause 15: The substrate of clause 14, wherein the coating is formed directly over a surface of the substrate.

Clause 16: The substrate of clause 14 or 15, wherein the coating forms a monocoat over at least a portion of the substrate.

Clause 17: The substrate of clause 14 or 15, wherein the coating forms at least one layer of a multi-layer coating.

Clause 18: The substrate of any of claims 14-17, wherein the substrate is a metal.

Clause 19: The substrate of any of claims 14-18, wherein the substrate forms at least a portion of an automotive vehicle.

The following examples are presented to demonstrate the general principles of the invention. The invention should not be considered as limited to the specific examples presented. All parts and percentages in the examples are by weight unless otherwise indicated.

### Examples 1-7

### General Description for the Preparation of Epoxy Powder Coating Compositions

Powder coating compositions for Comparative Example 1, Example 2, Comparative Example 3, Examples 4-6, and Comparative Example 7 were prepared following the procedure detailed below. Components listed in Table 1 were mixed in a Prism high speed mixer, and the mixture was passed through a 19 mm twin screw extruder (twin screw extruder supplied by Baker Perkins) utilizing a four-zone temperature profile: zone 1=80° C.; zone 2=100° C.; zone 3=100° C.; zone 4=100° C. The extrudate was cooled on chill rollers to create solid chips. The solid chips were then pulverized in a Prism high speed mixer and mixed with 0.15 weight percent of aluminum oxide. The mixture was ground in an air classifying mill (Mikro ACM®-1 Air Classifying Mill) and passed through a 100 mesh sieve to obtain a powder. Approximate particle sizes of each powder are summarized in Table 1.

TABLE 1

| | Comparative | Example | Comparative | Example | Example | Example | Comparative |
|---|---|---|---|---|---|---|---|
| Component | Example 1 | 2 | Example 3 | 4 | 5 | 6 | Example 7 |
| Epoxy resin A¹ (g) | 145.0 | 145.0 | 87.0 | 87.0 | 87.0 | 87.0 | 87.0 |
| Epoxy resin B² (g) | 145.0 | 0.0 | 87.0 | 0.0 | 0.0 | 0.0 | 0.0 |
| Organosolv lignin³ (g) | 0.0 | 145.0 | 0.0 | 87.0 | 0.0 | 0.0 | 0.0 |
| Kraft lignin⁴ (g) | 0.0 | 0.0 | 0.0 | 0.0 | 87.0 | 0.0 | 0.0 |
| Lignin derived from an | 0.0 | 0.0 | 0.0 | 0.0 | 0.0 | 87.0 | 0.0 |
| aqueous extraction | | | | | | | |
| process⁵ (g) | | | | | | | |
| Lignosulfonate⁶ (g) | 0.0 | 0.0 | 0.0 | 0.0 | 0.0 | 0.0 | 87.0 |
| Phenolic resin⁷ (g) | 61.0 | 61.0 | 36.6 | 36.6 | 36.6 | 36.6 | 36.6 |
| LUNAMER MB-68⁸ (g) | 1.0 | 1.0 | 0.6 | 0.6 | 0.6 | 0.6 | 0.6 |
| Accelerator⁹ (g) | 0.75 | 0.75 | 0.45 | 0.45 | 0.45 | 0.45 | 0.45 |
| Flow additive (g) | 6.2 | 6.2 | 3.72 | 3.72 | 3.72 | 3.72 | 3.72 |
| Benzoin (g) | 1.7 | 1.7 | 1.0 | 1.0 | 1.0 | 1.0 | 1.0 |
| Black pigment (g) | 7.3 | 7.3 | 4.4 | 4.4 | 4.4 | 4.4 | 4.4 |
| BaSO₄ (g) | 132.0 | 132.0 | 79.2 | 79.2 | 79.2 | 79.2 | 79.2 |
| Powder particle | 32 | 23 | 33 | 23 | 24 | 23 | 26 |
| size (μm)¹⁰ | | | | | | | |

¹NPES-903 epoxy resin commercially available from Nan Ya Plastics Corporation (Taiwan).
²EPON Resin 2004 commercially available from Hexion (Columbus, OH).
³LIGNOL lignin from Lignol Energy Corporation (Burnaby, Canada).
⁴BIOCHOICE Lignin commercially available from Domtar Corporation (Fort Mill, SC).
⁵Obtained from Renmatix, Inc. (King of Prussia, PA).
⁶MARASPERSE CBOS-4 commercially available from Borregaard Lignotech (Sarpsborg, Norway).
⁷EPIKURE P-202 commercially available from Hexion (Columbus, OH).
⁸Commercially available from Huangshang Deping Chemical Co. Ltd. (Huangshan, China).
⁹DYHARD MI-FF commercially available from AlzChem AG (Trostberg, Germany).
¹⁰Approximate particle size measured using a Beckman-Coulter LS ™ 13 320 laser diffraction particle size analyzer.

### Example 8

### Application and Evaluation of Coatings

The powder coating compositions of Examples 1-7 were applied to metal substrates (steel Q-panel, steel B-1000 panel, or aluminum Q-panel) at a dry film thickness of 2.0-3.0 mils (50-75 μm) using a Nordson electrostatic spray gun with a slot or conical tip. The coated panels were then baked in an electrical oven at 375° F. for 20 minutes.

The powder coating compositions and resulting coatings were also tested for various properties. The following properties and methods of determining the properties are described below.

Gloss: coated panels were evaluated for 20° and 60° specular gloss per ASTM D523-14 using a BYK Micro-TRI-Gloss meter.

Impact Resistance: direct- and reverse-impact resistance of the coatings on steel substrates were measured following ASTM D5420-16 using a Gardner impact tester. Impact resistance values, reported as inch-pounds (In.lb), were recorded at the highest level of impact at which no film removal or cracking was observed.

MEK Double Rubs: the extent of cure of each powder coating was assessed by investigating coating chemical resistance. A cotton ball soaked in methyl ethyl ketone (MEK) was rubbed back-and-forth over the coated substrate, and the number of MEK double rubs required to break through or mar the coating was recorded (up to 50 double rubs).

Water Double Rubs: the extent of cure of each powder coating was assessed by investigating coating chemical resistance. A cotton ball soaked in water was rubbed back-and-forth over the coated substrate, and the number of water double rubs required to break through or mar the coating was recorded (up to 50 double rubs).

Crosshatch Adhesion: Adhesion of the coatings to metal substrates was evaluated per ASTM D3359-17 Cross-Cut Tape Test. On a scale of OB-5B, a OB rating was assessed if the coating was completely removed using a pressure sensitive tape or 5B if no coating was lifted/removed between ⅛″ cross-hatch scribes.

Powder Gel Time: The gel time was determined according to the test method described in ASTM D4217-07. The interval at which the coating powder transformed from a dry solid to a gel-like state was measured at 180° C. on a polished hot surface. Measurement of the gel times assures that the powder coating will fully cure as a continuous film when applied.

Powder Stability: The powder coating compositions were stored at 40° C. for 7 days to assess stability (i.e., free-flowing, well-dispersed, non-aggregated particles).

The results of the previously described tests are listed in Table 2.

TABLE 2

| | Lignin | 180° C. | MEK | Water | | Crosshatch | |
|---|---|---|---|---|---|---|---|
| | Incorporation | Gel Time | Double | Double | Gloss | Adhesion | Storage Stability |
| Example | (wt %) | (min:ss) | Rubs | Rubs | 20°/60° | Score | (7 days/40° C.) |
| 1 | 0 | 0:55 | 50 | Not | 54/86 | 5B | Stable |
| | | | | measured | | | |
| 2 | 29 | 1:40 | 45 | Not | 42/86 | 5B | Stable |
| | | | | measured | | | |
| 3 | 0 | 0:45 | 50 | 50 | 56/86 | 5B | Not measured |
| 4 | 29 | 1:50 | 45 | 50 | 35/80 | 4B | Not measured |
| 5 | 29 | 1:40 | 45 | 50 | 0.1/2.6 | 5B | Not measured |
| 6 | 29 | 1:55 | 50 | 50 | 12/56 | 5B | Not measured |
| 7 | 29 | 2:10 | 35 | 20 | 3/23 | 5B | Not measured |

As shown in Table 2, epoxy powders prepared with organosolv lignin (Examples 2 and 4) demonstrated chemical resistance (MEK and water double rubs) that was comparable to Comparative Examples 1 and 3, which only used higher cost epoxy resins. The organosolv lignin-epoxy powder coatings also exhibited excellent gloss retention, crosshatch adhesion, and storage stability. As shown in Table 2, the epoxy powder prepared with Kraft lignin (Example 5) and lignin derived an aqueous extraction process (Example 6) demonstrated chemical resistance (MEK and water double rubs) and crosshatch adhesion that was comparable to Comparative Examples 1 and 3, which only used higher cost epoxy resins. Epoxy powder coatings containing a lignin polymer substantially free of sulfonate or sulfonic acid groups (Examples 2 and 4-6) exhibited enhanced chemical resistance (MEK and water double rubs) relative to Comparative Example 7, which used sulfonate-containing lignosulfonate polymers.

The coatings formed from Examples 1-2 were also evaluated for corrosion resistance. The corrosion performance was evaluated by salt spray resistance according to ASTM B117-18. Scribed coatings were prepared on BONDERITE 1000 steel panels and exposed to 5% salt fog at 35° C. and a 100% relative humidity chamber. Panels were inspected at 500 hour intervals and the longest duration at which no blistering or no significant corrosion creep underneath the scribe was recorded. The results of the corrosion testing is listed in Table 3.

TABLE 3

| | Average Scribe | Average Scribe | Average Scribe | Average Scribe |
|---|---|---|---|---|
| | Creep after | Creep after | Creep after | Creep after |
| | 500 hrs. | 1000 hrs. | 1500 hrs. | 2000 hrs. |
| Example | (mm) | (mm) | (mm) | (mm) |
| 1 | 2.8 | 4.5 | 9.0 | 12.0 |
| 2 | 1.8 | 4.3 | 3.7 | 6.5 |

As shown in Table 3, the epoxy powder coating prepared with organosolv lignin (Example 2) demonstrated better corrosion resistance after 500, 1000, 1500, and 2000 hours of salt spray exposure as compared to powder coatings prepared from Comparative Example 1.

The coatings formed from Examples 3-7 were also evaluated for corrosion resistance. The corrosion performance was evaluated by salt spray resistance according to ASTM B117-18. Scribed coatings were prepared on BONDERITE 1000 steel panels and exposed to 5% salt fog at 35° C. and a 100% relative humidity chamber. Panels were inspected at 500 hour intervals and the longest duration at which no blistering or no significant corrosion creep underneath the scribe was recorded. The results of the corrosion testing is listed in Table 4.

TABLE 4

| | Average Scribe | Average Scribe | Average Scribe | Average Scribe |
|---|---|---|---|---|
| | Creep after | Creep after | Creep after | Creep after |
| | 500 hrs. | 1000 hrs. | 1500 hrs. | 2000 hrs. |
| Example | (mm) | (mm) | (mm) | (mm) |
| 3 | 1.8 | 2.3 | 3.1 | 9.5 |
| 4 | 1.1 | 2.0 | 3.3 | 5.5 |
| 5 | 0.8 | 2.1 | 3.8 | 6.2 |
| 6 | 1.0 | 1.9 | 3.5 | 5.0 |
| 7 | Total coating | Total coating | Total coating | Total coating |
| | erosion | erosion | erosion | erosion |

As shown in Table 4, epoxy powders prepared with organosolv lignin (Examples 4), Kraft lignin (Examples 5), and lignin derived from an aqueous extraction process (Example 6) demonstrated better corrosion resistance at most times during the corrosion testing compared to Comparative Example 3. Epoxy powders prepared with sulfonate-containing lignosulfonate (Comparative Examples 7) exhibited total coating erosion and significant corrosion after 500 hours of salt spray exposure.

### Examples 9-15

### Preparation of Polyester Powder Coating Compositions

Polyester powder coating compositions for Comparative Example 9, Examples 10-12, Comparative Example 13, and Examples 14-15 were prepared following the procedure detailed below. Components listed in Table 5 were mixed in a Prism high speed mixer, and the mixture was passed through a 19 mm twin screw extruder (twin screw extruder supplied by Baker Perkins) utilizing a four-zone temperature profile: zone 1=80° C.; zone 2=100° C.; zone 3=100° C.; zone 4=100° C. The extrudate was cooled on chill rollers to create solid chips. The solid chips were then pulverized in a Prism high speed mixer and mixed with 0.2 weight percent of AEROSIL 200 hydrophilic fumed silica (commercially available from Evonik). The mixture was ground in an air classifying mill (Mikro ACM®-1 Air Classifying Mill) and passed through a 100 mesh sieve to obtain a powder. Approximate particle sizes of each powder are summarized in Table 5.

TABLE 5

| | Comparative | | | | Comparative | | |
|---|---|---|---|---|---|---|---|
| Example | Example 9 | Example 10 | Example 11 | Example 12 | Example 13 | Example 14 | Example 15 |
| Acid-functional polyester A¹¹ (g) | 273.0 | 245.7 | 191.1 | 136.5 | 0.0 | 0.0 | 0.0 |
| Acid-functional polyester B¹² (g) | 0.0 | 0.0 | 0.0 | 0.0 | 273.0 | 245.7 | 191.1 |
| Organosolv lignin³ (g) | 0.0 | 27.3 | 81.9 | 136.5 | 0.0 | 27.3 | 81.9 |
| Triglycidyl isocyanurate (g) | 20.4 | 20.4 | 20.4 | 20.4 | 20.4 | 20.4 | 20.4 |
| Dimethyl lauryl amine (g) | 1.25 | 1.25 | 1.25 | 1.25 | 0.0 | 0.0 | 0.0 |
| Benzoin (g) | 1.2 | 1.2 | 1.2 | 1.2 | 1.2 | 1.2 | 1.2 |
| IRGANOX 1076 (g) | 1.2 | 1.2 | 1.2 | 1.2 | 1.2 | 1.2 | 1.2 |
| RESIFLOW PL-200A (g) | 3.3 | 3.3 | 3.3 | 3.3 | 3.3 | 3.3 | 3.3 |
| Powder particle size (μm)¹⁰ | 26 | 27 | 24 | 22 | 35 | 34 | 30 |

¹¹An acid functional polyester having an acid value of 33 (on resin solids) and a weight average molecular weight (M_{w}) of 7,742 g/mol. The acid value for acid-functional polyester A was determined following a titration method similar to ASTM D1639. The acid value was determined by titration using a Metrohm Titrando autotitrator (Metrohm AG) with a solvotrode electrode for endpoint determination. Samples were dispersed in a mixture of 80 volume percent tetrahydrofuran and 20 volume percent propylene glycol, and standardized potassium hydroxide (methanolic, 0.1N) was used as the titrant. The weight average molecular weight (M_{w}) of acid-functional polyester A was determined using gel permeation chromatography. Gel permeation chromatography was performed using a Waters 2695 separation module (Waters Corporation) with a Waters 2414 differential refractometer (Waters Corporation). Tetrahydrofuran was used as the eluent at a flow rate of 1 mL/min, and two PLgel Mixed-C (300 × 7.5 mm) columns (columns obtained from Agilent Technologies, Inc.) were used for separation at room temperature. Number-average (Mₙ) and weight-average (M_{w}) molecular weights of polymeric samples were estimated relative to linear polystyrene standards of 800 to 900,000 Da (linear polystyrene standards obtained from Agilent Technologies, Inc.).
¹²CRYLCOAT 2441-2 commercially available from Allnex (Frankfurt, Germany).

### Example 16

### Application and Evaluation of Coatings

The powder coating compositions of Examples 9-15 were applied to metal substrates (steel Q-panel, steel B-1000 panel, or aluminum Q-panel) at a dry film thickness of 2.0-3.0 mils (50-75 μm) using a Nordson electrostatic spray gun calibrated with the following settings: 65 kV, 10 psi, slot tip. The coated panels prepared from the coating compositions of Examples 9-12 were baked in an electrical oven at 400° F. (204° C.) for 15 minutes. The coated panel prepared from the coating composition of Example 13 was baked in an electrical oven at 375° F. (191° C.) for 15 minutes. The coated panels prepared from the coating compositions of Examples 14-15 were baked in an electrical oven at 425° F. (218° C.) for 15 minutes.

The powder coating compositions and resulting coatings were tested for the various properties described in Example 8. The properties and methods of determining the properties are also described Example 8. The results of the previously described tests are listed in Table 6.

TABLE 6

| | | | | Direct | Reverse | |
|---|---|---|---|---|---|---|
| | Lignin | 180° C. | MEK | Impact | Impact | Crosshatch |
| | Incorporation | Gel Time | Double | Resistance | Resistance | Adhesion |
| Example | (wt %) | (min:ss) | Rubs | (In.lb) | (In.lb) | Score |
| 9 | 0 | 2:50 | 50 | 120 | 60 | 5B |
| 10 | 9 | 3:30 | 50 | 120 | 100 | 5B |
| 11 | 27 | 3:50 | 50 | 120 | 60 | 5B |
| 12 | 45 | 5:50 | 45 | 160 | 160 | 5B |
| 13 | 0 | 6:35 | 30 | Not | Not | Not |
| | | | | measured | measured | measured |
| 14 | 9 | 10:50 | 40 | Not | Not | Not |
| | | | | measured | measured | measured |
| 15 | 27 | 14:15 | 30 | Not | Not | Not |
| | | | | measured | measured | measured |

As shown in Table 6, the polyester powder coatings prepared with organosolv lignin and a curing catalyst (Examples 10-12) showed excellent chemical resistance (MEK double rubs) and excellent crosshatch adhesion. Incorporation of lignin with the polyester resin also afforded lignin-polyester coatings with enhanced impact resistance. Powder coatings prepared with organosolv lignin and no curing catalyst (Examples 14-15) showed chemical resistance (MEK double rubs), indicating that the coating was fully cured.

Whereas particular embodiments of this invention have been described above for purposes of illustration, it will be evident to those skilled in the art that numerous variations of the details of the present invention may be made without departing from the invention as defined in the appended claims.

The invention claimed is:

1. A powder coating composition comprising:
a film-forming resin;
a lignin polymer that is substantially free of sulfonate or sulfonic acid groups; and
a crosslinker reactive with the functional groups of the film-forming resin and the lignin polymer,
wherein the lignin polymer comprises at least 5 weight % of the powder coating composition, based on the total solids weight of the powder coating composition, and
wherein, when cured to form a coating, the film-forming resin and lignin polymer react and chemically bond with the crosslinker to form a binder of the coating.

2. The powder coating composition of claim 1, wherein the lignin polymer comprises at least 9 weight % of the powder coating composition, based on the total solids weight of the powder coating composition.

3. The powder coating composition of claim 1, wherein the lignin polymer comprises at least 20 weight % of the powder coating composition, based on the total solids weight of the powder coating composition.

4. The powder coating composition of claim 1, wherein the lignin polymer is completely free of sulfonate or sulfonic acid groups.

5. The powder coating composition of claim 1, wherein the lignin is selected from an organosolv lignin, Kraft lignin, soda lignin, lignin derived from a liquid extraction processes or ethanol production processes, or combinations thereof.

6. The powder coating composition of claim 1, wherein the film-forming resin comprises a polyester polymer, an epoxy polymer, an (meth)acrylic polymer, a copolymer thereof, or combinations thereof.

7. The powder coating composition of claim 1, wherein the film-forming resin comprises a carboxylic acid functional polyester polymer.

8. The powder coating composition of claim 1, wherein the film-forming resin comprises an epoxy functional resin.

9. The powder coating composition of claim 8, wherein the epoxy functional resin comprises a bisphenol A epoxy functional resin.

10. The powder coating composition of claim 1, wherein the film-forming resin has a glass transition temperature of at least 45° C.

11. The powder coating composition of claim 1, wherein the crosslinker comprises an epoxy functional crosslinker, a phenolic functional crosslinker, an isocyanate functional crosslinker, a hydroxyl functional crosslinker, or a combination thereof.

12. The powder coating composition of claim 1, further comprising a catalyst.

13. The powder coating composition of claim 1, wherein the coating composition is substantially free of a catalyst.

14. A substrate at least partially coated with the coating formed from the powder coating composition of claim 1.

15. The substrate of claim 14, wherein the coating is formed directly over a surface of the substrate.

16. The substrate of claim 14, wherein the coating forms a monocoat over at least a portion of the substrate.

17. The substrate of claim 14, wherein the coating forms at least one layer of a multi-layer coating.

18. The substrate of claim 14, wherein the substrate is a metal.

19. The substrate of claim 14, wherein the substrate forms at least a portion of an automotive vehicle.
